(19) United States
(12) Patent Application Publication
(10) Pub. No.: US 2002/0186122 A1
(43) Pub. Date: Dec. 12, 2002

(54) Method and apparatus for indicating at an alerting device, that information has been received by a communication device

(75) Inventor: Narayan Gehlot, Sayreville, NJ (US)

Correspondence Address: LAW OFFICE OF JOHN LIGON, 505 HIGHLAND AVENUE, P.O. BOX 43485, UPPER MONTCLAIR, NJ, 07043, US

(73) Assignee: Lucent Technologies Inc., Murray Hill, NJ

(21) Appl. No.: 09/878,458

(22) Filed: Jun. 11, 2001

(51) Int. Cl. H04Q 1/30

(52) U.S. Cl. 340/7.58; 340/407.1

(57) ABSTRACT

An apparatus for alerting a user at an alerting device that data has been delivered to a wireless communication device includes an adapter that receives a data receipt signal from the communication device and activates an associated alerting device after verifying its identify. Verifying the identity of the alerting device includes comparing an alerting device identifier, which is either stored or delivered to the alerting device from a remote location, with a communication device identifier that is embedded or otherwise included with the data that is delivered to the associated communication device. The alerting device is activated if the comparison shows that the alerting device is that which corresponds to the communication device that received the data. Alerting devices may be incorporated into jewelry, garments releasable straps and other objects that are convenient for the user.

### BACKGROUND OF THE INVENTION

1. Field of the Invention

The present invention relates to alerting devices, and more particularly to enabling inaudible alerting devices to notify the user of a communication device that data has been received.

2. Description of the Related Art

The use of wireless communication is increasing at an exponential rate. As a result, there have been many attempts among service providers and manufacturers of the hardware implemented in the wireless systems to provide options to the users that enable more convenience and enhanced user-friendly access to the services. Among these attempts have been the implementation of alternate methods for alerting the user of the occurrence of an event, particularly the occurrence of an incoming communication signal or request. For example, with radio paging devices, the user generally has two options for setting the alert type when an incoming page is received: (i) an audible tone to indicate the presence of an incoming page, or alternatively (ii) a vibration mode to vibrate the device when the incoming page is received. The vibration mode of the radio pager serves the same intended function of obtaining the user's attention when an incoming page is received but attempts to do so in a silent manner so as to not disturb the user or persons surrounding or proximate the user when the page is received. Wireless telephones are similar in that they often provide a vibration mode in addition to an audible tone mode, for indicating the presence of an incoming telephone call.

While the use of vibration to alert a user is useful under certain circumstances, it is sometimes impractical. First, while the vibration mode is not as disturbing as an audible tone, persons in the user's immediate vicinity can sometimes detect the sounds that are generated when such a device is operating. Also, the vibration is created using a series of moving, mechanical parts, which can add significant size and weight to the device. Further the pagers, cellular telephones and other devices that are in vibration mode must typically be placed in physical contact with the user's body in order to alert the user. Thus, while the vibration mode is included in these devices to make their use more convenient, factors such as those described here often produce the opposite result. There is a need for a more effective device that can immediately and inaudibly alert a user that data has been delivered to a wireless communication device.

### SUMMARY OF THE INVENTION

In accordance with an embodiment of the invention, a method of indicating at an alerting device that data has been delivered to a communication device includes activating a data receipt indicator, extracting a communication device identifier from the data, modulating the carrier signal of the communication device identifier, transmitting the communication device identifier to an alerting device, demodulating the carrier signal, decoding the communication device identifier and causing operation of the alerting device if the communication device identifier corresponds to an identifier associated with the alerting device.

In another embodiment, a circuit for indicating at an alerting device that data has been delivered to a communication device includes a data receiver, a data receipt indicator which generates an inaudible output in response to delivery of the data to the data receiver, a communication device identifier detector which detects a communication device identifier that is delivered with the data, a communication device identifier transmitter which transmits the communication device identifier and an alerting device which varies an output in response to a value of said communication device identifier.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote similar elements throughout the several views:

FIG. 1 illustrates generally, an available system for conducting wireless communications between two devices;

FIG. 2 is a schematic representation of a system for indicating that data has been delivered to an alerting device in accordance with an embodiment of the present invention;

FIG. 3 is a block diagram of a method for indicating that data has been delivered to an alerting device in accordance with an embodiment of the present invention;

FIG. 5A illustrates a prior art communication device capable of generating an audible output;

FIGS. 5B-5F illustrate various embodiments of communication devices that have been configured to generate inaudible output in response to the receipt of data, in accordance with an embodiment of the invention;

FIG. 6 is a block diagram that illustrates a method for activating an alerting device according to an embodiment of the invention;

FIG. 7 illustrates circuitry for transmitting a communication device identifier in accordance with the invention;

FIG. 8 illustrates circuitry for verifying the identity of an alerting device in accordance with the invention; and

FIG. 9 illustrates a communications device linked to its associated alerting device in accordance with an embodiment of the invention

FIG. 10 shows an exemplary circuit that can be incorporated into the alerting device to increase the life of its battery.

### DETAILED DESCRIPTION OF THE PREFERRED EMBODIMENTS

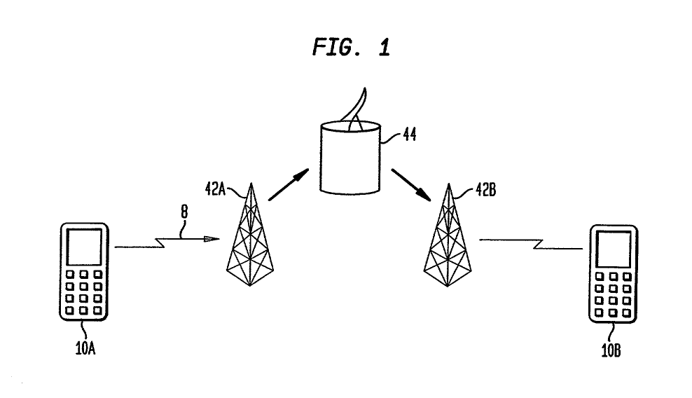

Referring now to the drawings which are provided to describe embodiments of the invention and not by way of limitation, FIG. 1 illustrates an available system that facilitates communications between wireless devices 10A and 10B. As shown, a sending device 10A transmits data 8 to a base station 42A which relays the data to a satellite 44. Examples of common types of data 8 include voice data and alpha-numeric data, such as that used for paging devices or included in electronic mail notes. Satellite 44 determines the location of receiving communications device 10B, and transmits data 8 to a base station 42B that is in its vicinity. Data 8 is then transmitted from base station 42B to receiving device 10B.

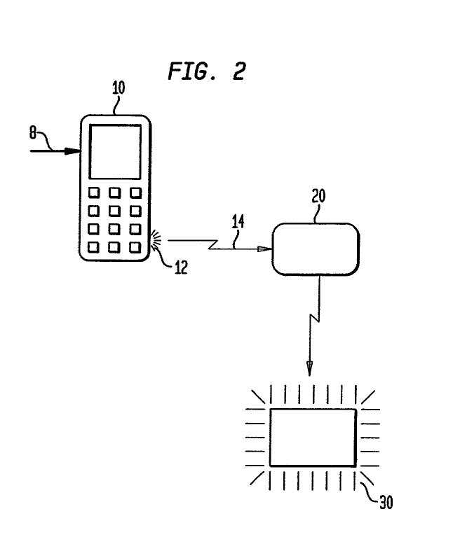

Turning to FIG. 2, in one embodiment of the invention, a system for indicating that data 8 has been delivered to a communication device includes an alerting device 30 which is electronically linked to communications device 10 via an adapter 20. As stated earlier, communication device 10 may be any device that is capable of completing wireless electronic communications, such as a mobile telephone, a digital pager, a personal digital assistant, a laptop computer or similar device. Alerting device 30 may be any device that can be used to get a user's attention, and will preferably, but not necessarily, be a device that will get the attention of the user without getting the attention of others around him. Examples of alerting devices 30 that may be used with the invention are disclosed in U.S. Pat. No. 6,181,237 to Gehlot, issued Jan. 30, 2001, the contents of which are hereby incorporated by reference in its entirety, which discloses an alerting device 30 that can be implemented into jewelry, garments, releasable straps and other objects that are easily placed in contact with a user. A level of pressure that is applied to the user's skin can be varied to notify the user about the occurrence of an event. Other alerting devices vary the temperature that is applied to a user's skin or to activate an illuminating color of a device (e.g. a light emitting diode) as disclosed in U.S. Ser. No. 09/421,127 to Gehlot filed Oct. 19, 1999 and in U.S. Ser. No. 09/420,827 to Gehlot filed Oct. 19, 1999, the contents of which are hereby incorporated by reference in their entirety. Alerting devices such as these do not have to be physically attached to the communications device 10 to which they are linked, yet they can be used, in accordance with various embodiments of the invention, to alert a user that data 8 has been delivered to a communications device 10.

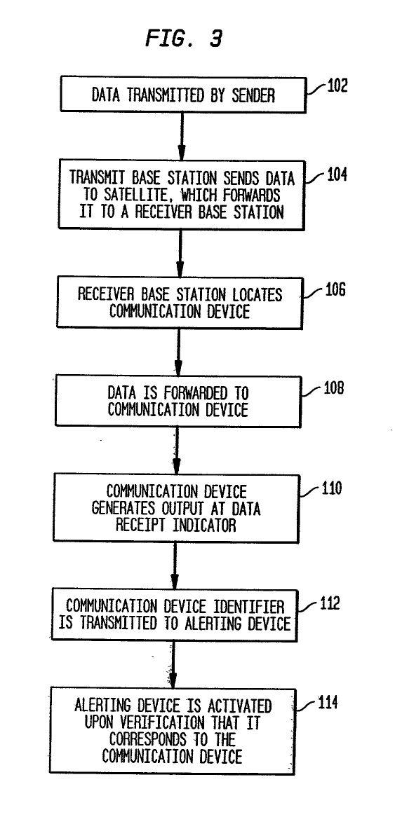

Steps that may be followed to activate alerting device 30 in accordance with embodiments of the invention and thus, indicate that data has been delivered to communication device 10 are provided in FIG. 3. Data 8 is transmitted by a sender as illustrated in block 102. As described earlier, data 8 is transmitted to a nearby base station at block 104, relayed to a communications satellite and forwarded to a base station near the receiving communication device 10. The receiving base station uses information that is provided at the beginning of data 8 to locate the receiving communication device 10 to which data 8 will be delivered as shown in block 106. Data 8 is then transmitted to communications device 10 as shown in block 108.

Still referring to FIG. 3, in one embodiment, when data 8 is delivered to communication device 10, the device produces an inaudible output at data receipt indicator 12, as indicated in block 110. In one embodiment, output from data receipt indicator 12 is a laser output, such as an infrared output. The output at data receipt indicator 12 initiates transmission of a communication device identifier, which identifies the communication device 10 to which data 8 has been delivered, to an appropriate alerting device 30 as illustrated in block 112. An alerting device identifier, which may be either stored in alerting device 30 or delivered to it from a remote location, is used to verify that the alerting device 30 that receives the communication device identifier is the one that corresponds to the communication device 10 to which data 8 was delivered. If so, alerting device 30 is activated at block 114 to notify the user that data 8 has been delivered.

In one embodiment, generating output at data receipt indicator 12 (block 110 of FIG. 3) takes place as illustrated in FIG. 4. A data receipt signal is generated in response to the delivery of data 8 to communication device 10, as shown in block 202. This data receipt signal is then input to a data receipt indicator circuit as indicated in block 204. Data receipt signal will typically be a signal such as that generated in prior art devices to cause ringing or the generating of other sounds in a cellular telephone, or the playing of beeps or other tones in pagers, electronic mail application programs and other devices. Thus, without modification, the data receipt indicator circuit produces the audible sounds and/or vibration of the device. In accordance with the invention, the data receipt signal may be intercepted and directed to an inaudible output as shown in block 206. The inaudible output is then produced at data receipt indicator 12 as indicated in block 208.

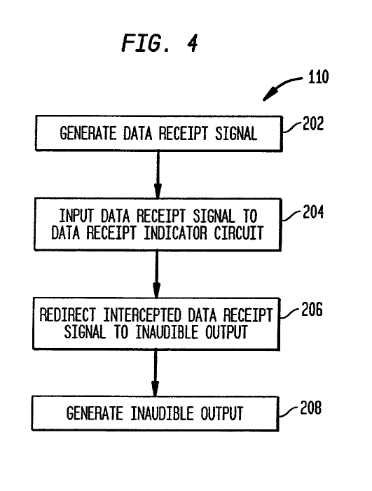

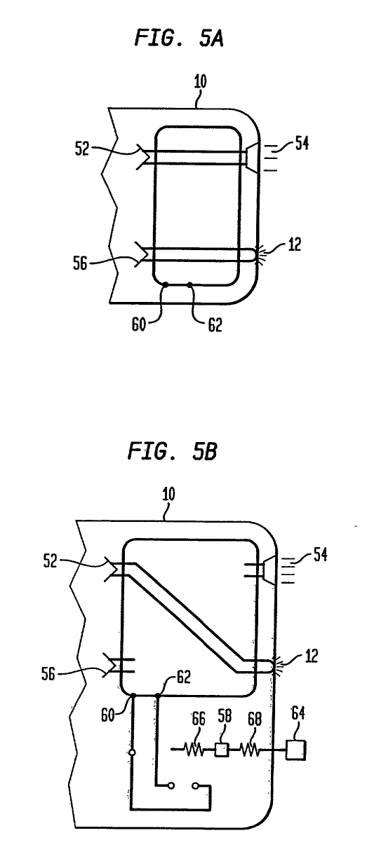

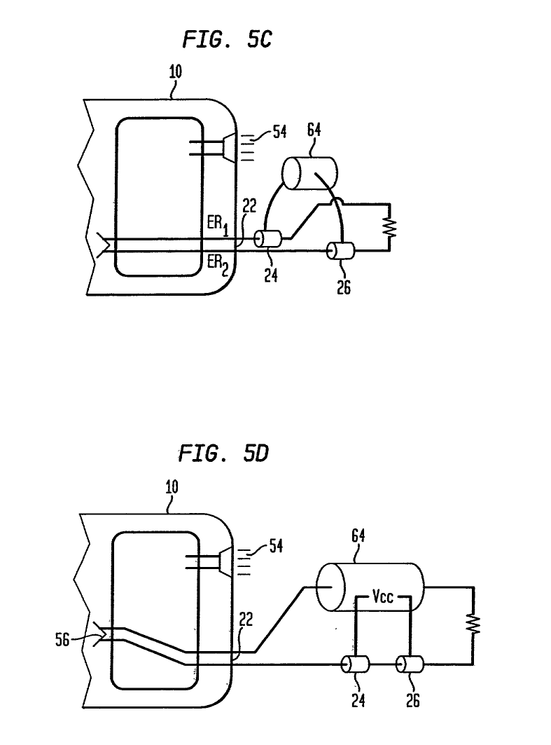

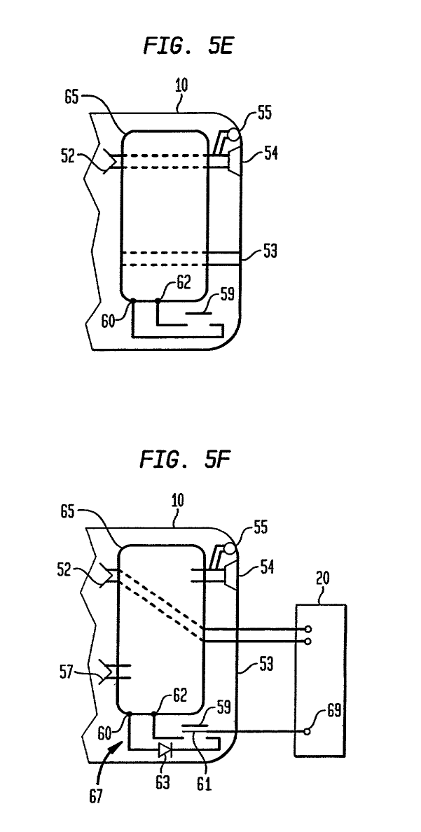

Exemplary embodiments of the circuitry that may be used to generate inaudible output in accordance with embodiments of the invention are described with reference to FIGS. 5A-5F. Turning first to FIG. 5A, available devices are typically provided with a circuit that is capable of generating an audible output such as a ring, tone or beep, when data 8 is received. In such a device a data receipt signal is delivered to the circuit at input 52, and a ring or other audible sound is produced through a speaker 54, which is typically located on one or more surfaces of communications device 10. Available devices often also include an IR port 56, where a laser or other infrared signal may be delivered, and a data receipt indicator 12 (e.g. an IR output), from which an infrared signal may be transmitted. While the device of FIG. 5A is shown having separate locations for transmitting and receiving infrared data, it is to be understood that a single, bi-directional port could be provided. Although currently available devices are capable of transmitting infrared outputs, no such devices directly generate laser or similar outputs in response to the receipt of non-infrared data.

Currently available circuitry may be modified in various ways to generate inaudible output (e.g. an infrared signal) in response to the receipt of data as shown in FIGS. 5B-5F. The data receipt signal that is delivered to communication device 10 at input 52 may be intercepted before any vibration takes place and before any sounds are generated at speaker 54, and the signal may be directed instead to data receipt indicator 12. In such an embodiment, communications device 10 can generate an IR output in response to the receipt of data 8, instead of an audible sound, such as a ring. The IR output is then detected by adapter 20.

As illustrated in FIG. 5B, in one embodiment of the invention, adapter 20 may be placed adjacent to data receipt indicator 12, to allow it to detect the IR output. For example, adapter 20 could be a device that snaps onto communication device 10 at a position that will allow it to receive the output from data receipt indicator 12. In such an embodiment, the circuitry of communications device 10 could be modified as shown. Adapter 20 includes an IR detector 64, an electrical contact 66 and a non-conducting spacer 58, placed between adapter terminal 64 and power source 60. IR detector plugs into connector 62, which electronically links it, via contact 66, to data receipt indicator 12. Such a circuit would enable IR detector 64 to receive the infrared output when it is transmitted from data receipt indicator 12. In another embodiment, wires in an IR output, such as an LED driver circuit, can be tapped, by placing the leads of the LED transmitter at connection points 60 and 62, for attachment to adapter 20. It should be noted that the circuitry shown in FIG. 5B could be installed by the manufacturer or it could be a plug in device that is added by the user. While the invention is described as generating an infrared output, it is to be understood that it could be used to generate other outputs, in accordance with the capabilities of communications device 10.

In another embodiment of the invention, the data receipt signal could be detected by induction rather than by generating an infrared output. As illustrated in FIG. 5C, EMF sensors 24 and 26 could be attached to the wires of a headset, earphone or other attachment that may be inserted into a port on the surface of communication device 10. The attachment may then be plugged into communication device 10 at its ordinary location. In such an embodiment, plugging the attachment connector into device 10 will disconnect speaker 54 and cause the data receipt signal to be directed to attachment port 22. EMF sensors 24 and 26 could then detect the transmission of signals through the wires. The strength of the signal will typically not be uniform throughout the wires, and therefore, a signal strength differential can be detected by sensors 24 and 26. Output from sensors 24 and 26 can be connected to adapter terminal 64, and the differential will indicate, via adapter 20, that data 8 has been delivered to communication device 10. In another embodiment, EMF sensors 24 and 26 could be built into the attachment as illustrated in FIG. 5D rather than provided as clip-on or otherwise attachable devices. Such an embodiment will prevent the user from having to attach hardware to the wires.

In still another embodiment, a switch such as a double pole, double throw (DPDT) switch 65 known by those skilled in the art, could be used to direct the data receipt signal to adapter 20. As shown in FIG. 5E, communication devices 10 are sometimes provided with multiple data receipt indicators, such as, for example, both a speaker 54 and an LED 55. As before, the data receipt signal is delivered to input 54. A mechanical switch can be used to select between speaker 54 and LED 55 to generate the output.

In an embodiment of the invention, adapter 20 could be used to detect the data receipt signal at an external connector 53, which is typically a connector that can be used to attach communication device 10 to an ac power source, such as a wall outlet or an automobile cigarette lighter. Adapter 20 could plug into external connector 53 to disconnect speaker 53 and LED 55, and connect adapter 20 to the ringer circuit. In such a device, mechanical switch 59 will close to allow current to flow through circuit 67 when data 8 is received. Connecting adapter 20 to the ringer circuit will enable it to detect the receipt of data 8.

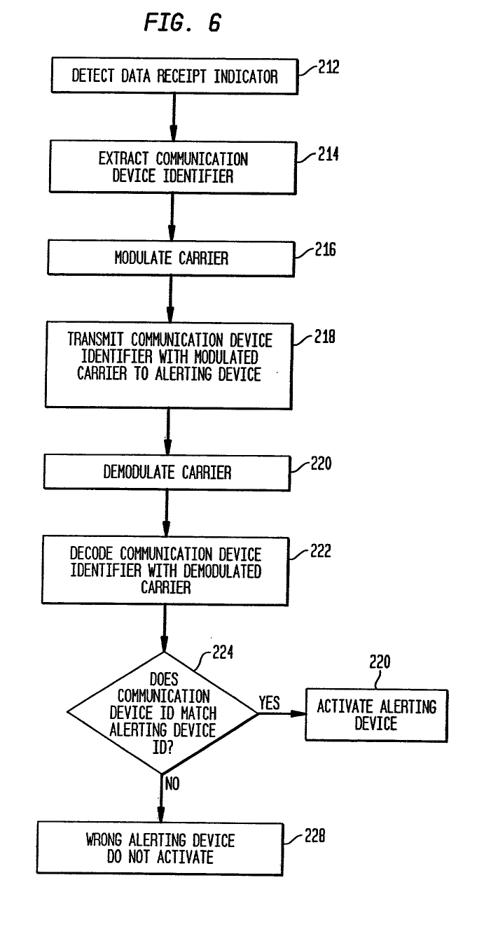

Referring to FIG. 6, after adapter 20 detects the output at data receipt indicator 12 at block 212, it extracts a communications device identifier from data 8 as shown in block 214. As stated earlier, information that identifies the communication device 10 to which data 8 is directed is included in each data transmission, typically at the beginning. For example, when communication device 10 is a mobile telephone or a pager, the transmission will typically begin with information that relates to its telephone number. Adapter 20 receives this identifying information and generates a communication device identifier, which can be used to verify that the appropriate alerting device 30 will be activated. The communication device identifier and the rest of data 8 are used to modulate a carrier signal, as shown in block 216. The modulated carrier signal is then transmitted to an alerting device 30 as illustrated in block 218.

Still referring to FIG. 6, after alerting device 30 receives the communication device identifier, the carrier signal is demodulated as shown in block 220. Separate from this process, alerting device 30 is provided with its own identifier which associates it with the communication device 10 to which it is electronically linked or otherwise associated. In one embodiment, this identifier is stored in a memory in alerting device 30. In another embodiment, the alerting device identifier may be transmitted from a remote location. In any event, the communication device identifier is decoded to transform it into a recognizable format as shown in block 222, and the communication device identifier and the alerting device identifier are compared. As stated earlier, the communication device identifier identifies the communication device 10 to which data 8 will be delivered, and the alerting device identifier typically matches (or corresponds to via a mapping or some other scheme) the communication device identifier of the communication device 10 to which it is linked. Thus, as shown in block 224, a match between the alerting device identifier and the communications device identifier that is received indicates that alerting device 30 corresponds to the communication device 10 that received data 8. Alerting device 30 will then be activated as shown in block 226. When the two values that are compared at block 224 do not match, it means that the incorrect alerting device 30 has been contacted, and the device will not be activated as shown in block 228.

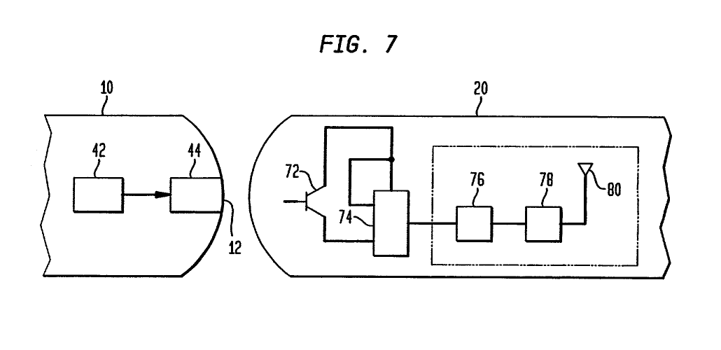

Referring now to FIG. 7, in one embodiment a circuit for activating an alerting device 30 in response to the receipt of data 8 includes a data receipt indicator 12, a data detector 72 and a communication device identifier transmitter 80. Data receipt indicator 12 generates an output when data 8 is delivered to data receiver 52 (illustrated in FIG. 5B). Data detector 72 detects output at data receipt indicator 12 by communications device 10. Data 8 then passes to a radio frequency transmitter (RF-Tx) circuit 100, which includes a communication device identifier generator 76 and a modulator 78. As stated earlier, communication device identifier generator 76 generates a communication device identifier using information that is embedded or otherwise included in data 8.

Communication device identifier transmitter 80 transmits the communication device identifier to an alerting device 30 to activate the device and alert a user that data has been delivered to communication device 10. In one embodiment, alerting device 30 may be placed in contact with the user's skin. As stated earlier, alerting device may be incorporated into jewelry, garments, releasable straps and other objects that may typically be worn by a user. Activating alerting device 30 may include varying its output. For example, in one embodiment, activating alerting device 30 may vary an amount of pressure that is applied to the user's skin. In another embodiment, the device may be activated by varying its temperature. In another embodiment, alerting device 30 may simply be placed inside the user's view, and its color, illumination level or other visible output may be varied in response to the receipt of data 8. Such an embodiment may include a light emitting diode, liquid crystal display or other device or display whose visual appearance can be changed.

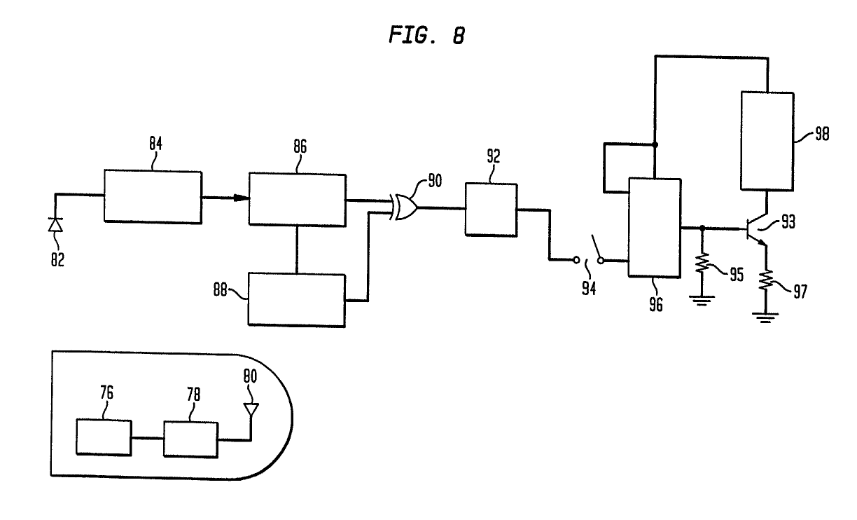

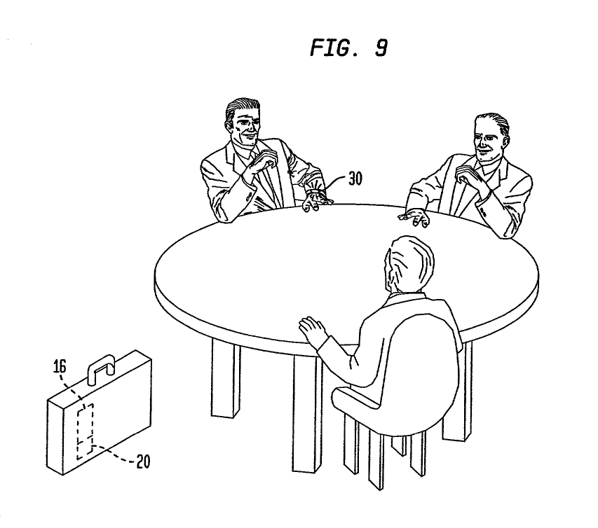

Alerting device 30 may be activated in various ways. In one embodiment, the amount of power that is delivered to the device may be varied in response to the transmission of the communication device identifier from adapter 20. The change in power can then be used to vary the pressure, temperature or color of alerting device 30. Referring to FIG. 8, in one embodiment, the communication device identifier may be transmitted from communication device identifier transmitter 80 to alerting device receiver 82. The communication device identifier is then passed to demodulator 84 and to a decoder 86 for comparison to the alerting device identifier that has been stored or delivered to location 88. The two identifiers are compared and when they correspond alerting device 30 can be activated.

In the embodiment of the invention illustrated in FIG. 8, output from decoder 86 and alerting device identifier location 88 are input to exclusive or gate (XOR) 90. In this embodiment, alerting device 30 will be activated when the communication device identifier and the alerting device identifier are an exact match. That is, switch 94 will only allow current to flow through the circuit to alerting device 30 when the output of XOR 90 is high. The flow of current through the circuit turns on the power to resister 98, thereby varying the output (e.g. pressure, temperature, color, etc.)of alerting device 30.

In accordance with another embodiment of the present invention, alerting device 30 is connected with communication device 10 via a wireless connection, such for example radio frequencies (RF). As shown in FIG. 9, communication device 10 and adapter 20 may be placed at a distance from the user, such as inside a briefcase or a desk or at any other location within the operating range of the system. The alerting device 30 may be placed in physical contact with the user's person or body (preferably the user's skin), within the user's view or in another appropriate position. It may be initially set or adjusted to a predetermined rest pressure, temperature, color or other variable characteristic. The rest variable may be preset, during design or manufacture, equal to that which corresponds to a typical surrounding environment or it can be dynamically set by alerting device 30. When data is delivered to communication device 10, the corresponding alerting device 30 is activated to vary the appropriate output characteristic. The user can decide whether to retrieve communication device 10 and access data 8, or to ignore alerting device 30 as desired.

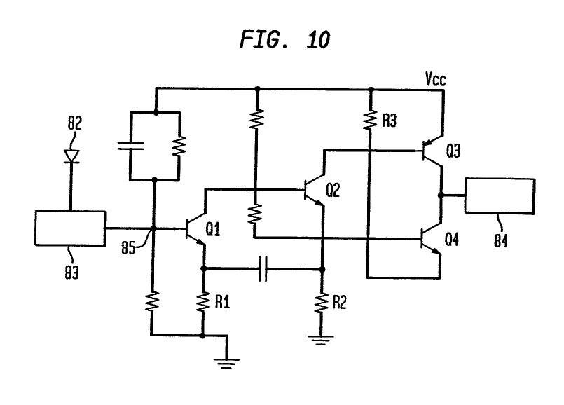

In one embodiment, a timer, counter or other device may be included in the method and circuit to cause alerting device 30 to turn off when the user chooses to ignore the incoming data or otherwise does not respond within a designated amount of time. Alerting device 30 may also be provided with a cut off switch to allow the user to turn alerting device 30 on and off at will. As illustrated in FIG. 10, circuitry can be added to extend the life of the alerting device battery. While no data is being received at alerting device receiver 82, no signal will be generated at controller 83. Under these circumstances, controller 83 can be used to oscillate or otherwise suspend the supply of power at input 85. In one embodiment, controller 83 will use a time based method to determine whether power will be supplied to altering device 30. For example, in one embodiment, controller 83 will supply power to demodulator 84 10% of the time (e.g. the first of every ten seconds). In this manner, alerting device 30 will have power often enough, to allow for monitoring of alerting device receiver 82 to cause it to respond when data 8 is delivered.

It is, therefore, apparent that there has been provided, in accordance with the present invention, a method and apparatus for indicating at an alerting device that information has been received by a communication device. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method of indicating at an alerting device that data has been delivered to a communication device, comprising:
activating a data receipt indicator;
transmitting a communication device identifier to an alerting device; and
causing operation of said alerting device if said communication device identifier corresponds to an identifier associated with said alerting device.

2. A method as claimed in claim 1 wherein said data receipt indicator is inaudible.

3. A method as claimed in claim 2 wherein said data receipt indicator emits an infrared signal.

4. A method as claimed in claim 1 wherein said communication device identifier is embedded in the data that has been delivered to the communication device.

5. A method as claimed in claim 1 wherein activating said data receipt indicator further comprises:
generating a data receipt signal when the data is delivered to the communication device;
inputting said data receipt signal to a data receipt circuit;
intercepting said data receipt signal and directing said intercepted signal to an inaudible output producing portion of said data receipt circuit; and
producing an inaudible output.

6. A method as claimed in claim 1 wherein transmitting said communication device identifier further comprises:
detecting an inaudible output produced by said data receipt indicator;
modulating a carrier portion of said communication device identifier; and
transmitting said communication device identifier with said modulated carrier portion to said alerting device.

7. A method as claimed in claim 1 wherein causing operation of said alerting device further comprises:
demodulating a carrier portion of said communication device identifier;
decoding said communication device identifier with said demodulated carrier portion;
comparing said communication device identifier with said alerting device associated identifier; and
activating said alerting device if said destination identifier corresponds to said alerting device associated identifier.

8. A method as claimed in claim 1 wherein activating said alerting device further comprises varying a temperature of at least a user contacting portion of said alerting device.

9. A method as claimed in claim 1 wherein activating said alerting device further comprises varying a pressure applied by at least a portion of said alerting device.

10. A method as claimed in claim 1 wherein activating said alerting device further comprises varying an illumination level of at least a portion of said alerting device.

11. A method of indicating at an alerting device that data has been delivered to a communication device, comprising:
activating an inaudible indicator in response to delivery of the data to the communication device;
modulating a carrier portion of a communication device identifier that was included in the data delivered to the communication device;
transmitting said communication device identifier with said modulated carrier portion to an alerting device;
demodulating a carrier portion of said communication device identifier;
decoding a communication device identifier with said demodulated carrier portion;
comparing said decoded communication device identifier and demodulated carrier portion with an identifier associated with said alerting device; and
activating said alerting device if said communication device identifier corresponds to said alerting device identifier.

12. A method as claimed in claim 11 wherein activating said altering device further comprises varying a temperature, a pressure or an illumination level of at least a portion of said altering device.

13. A method as claimed in claim 11 wherein said communication device identifier includes a sequence of bits.

14. A method as claimed in claim 11 wherein said communication device identifier is embedded in a transmission from a communications satellite.

15. A system for indicating at an alerting device that data has been delivered to a communication device, comprising:
a data receiver;
a data receipt indicator which generates an output in response to delivery of the data to said data receiver;
a communication device identifier detector which detects a communication device identifier delivered with the data;
a communication device identifier transmitter which transmits said communication device identifier; and
an alerting device which varies an alerting device output in response to a value of said communication device identifier.

16. A system for indicating at an alerting device that data has been delivered to a communication device, comprising:
a data receiver;
a data receipt indicator which emits an inaudible output in response to delivery of the data to said data receiver;
a communication device identifier detector which detects a communication device identifier embedded in the delivered data;
a communication device identifier transmitter which transmits said communication device identifier; and
an alerting device which varies an alerting device output when said communication device identifier corresponds to a value that is stored in a memory linked to said alerting device.

17. A method of forwarding an identifying portion of data delivered to a communication device, comprising:
detecting an infrared signal that indicates that data has been delivered to the communication device;
accepting an identifying portion of said data;
modulating a carrier portion of said data; and
transmitting said identifying portion to the output device with said modulated carrier portion.

18. A method of forwarding a data delivery notification to an alerting device, comprising:
receiving a communication device identifier embedded in a set of data delivered to an associated communication device;
modulating a carrier portion of said communication device identifier; and
transmitting said communication device identifier with said modulated carrier portion to said alerting device.

19. A method of alerting the user of an output device to the presence of incoming data, comprising:
delivering a communications device identifier to an alerting device;
demodulating a modulated carrier portion of said identifying portion;
decoding said identifying portion;
comparing said identifying portion to verification data;
varying a power delivered to an alerting device if said comparison indicates that said identifying portion corresponds to said verification data.

20. A method as claimed in claim 19 further comprising altering a level of applied pressure in response to said power variation.

21. A method as claimed in claim 19 further comprising altering a temperature in response to said power variation.

22. A method as claimed in claim 19 further comprising changing an illumination level of a light emitting device in response to said power variation.

23. A method as claimed in claim 19 wherein varying said alerting device delivered power further comprises varying the power delivered to a resistor included in an alerting circuit.

24. A system for indicating at an alerting device that data has been delivered to a communication device, comprising;
a data receipt notification circuit;
an audible output connectable to said notification circuit;
an inaudible output connectable to said notification circuit; and
a user control which enables a user to connect one of said inaudible output and said audible output to said notification circuit.

25. A system as claimed in claim 24 wherein said user control accepts insertion of a metallic pin into an aperture in said communication device.

26. A system as claimed in claim 25 wherein said metallic pin insertion connects an infrared port to said data receipt notification circuit.

27. A system as claimed in claim 24 wherein said inaudible output is an infrared output.

28. A system as claimed in claim 24 wherein said communication device is a wireless communication device.

29. A system as claimed in claim 28 wherein said wireless communication device is a cellular telephone.

30. A system as claimed in claim 28 wherein said wireless communication device is in a laptop computer.

31. A system as claimed in claim 28 wherein said wireless communication device is a personal digital assistant.

32. A system for forwarding a data delivery notification to an alerting device, comprising:
a communication device identifier detector;
a communication device identifier modulator; and
a modulated communication device identifier transmitter.

33. A system for alerting a user that data has been delivered to a wireless communication device, comprising:
a demodulator which demodulates a carrier portion of the data;
a decoder linked to said demodulator to decode a data receiver identifier portion of the data;
a memory in which an identifier is stored;
a comparing circuit which compares said stored identifier to said data receiver identifier portion; and
a power supply which varies an amount of power delivered to an alert circuit, thereby activating a user identifiable alert.
